(19) United States
(12) Patent Application Publication
(10) Pub. No.: US 2005/0179517 A1
(43) Pub. Date: Aug. 18, 2005

(54) Retrofit electronic lock security system

(76) Inventors: Mark R. Harms, Kennedy, NY (US); William H. Spaulding, Dover, PA (US); Richard B. Jermain, Falconer, NY (US); Roy J. Glosser, Mayville, NY (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/780,331

(22) Filed: Feb. 17, 2004

(51) Int. Cl. G06F 7/04

(52) U.S. Cl. 340/5.9; 70/277; 340/5.73; 340/5.65

(57) ABSTRACT

Systems and techniques for providing a locker system include providing a locker unit having a housing structured and arranged to be retrofit to an existing key operated locker and an electronically controlled locking mechanism enabling keyless entry into the locker.

### TECHNICAL FIELD

The present invention relates generally to a locker system for securing objects and, more particularly, to a retrofit electronic locker security system.

### BACKGROUND

Many exiting locker systems are coin and key operated. Vendors of such locker systems are required to maintain an inventory of keys and also must incur expenses when replacing lost or damaged keys. Recently, electronic locker systems have been developed that incorporate keypads allowing a user to set and enter a personal identification number (PIN) to gain access to a locker. While these electronic locker systems eliminate the need for keys, replacing an existing coin and key operated locker system with a new electronic locker system is not an economically viable alternative for many vendors.

Accordingly, there is a need for an electronic lock security system that can be retrofit to existing coin and key operated locker systems.

### SUMMARY

In one general aspect, a lock unit includes a housing structured and arranged to be retrofit to an existing key operated locker and an electronically controlled locking mechanism enabling keyless entry into the locker.

Implementations may include one or more of the following features. For example, the unit may include a user interface for receiving an entry code from a user. The user interface may include a keypad and/or a display panel (e.g., a vacuum florescent display, a liquid crystal display, and a light emitting diode display). The locking mechanism may be mounted to a lock channel of an existing key operated locker system, may include a cylinder for receiving a control key, and/or may include a patron cylinder having a knob. Manually turning the knob may move a deadbolt. The lock unit may include one or more coin slots and electronics structured and arranged to fit inside a cavity of a locker door. The electronics may include one or more of a micro-controller, a power supply, a power supply, a motor controller, sensors and a network interface.

Aspects of the present invention may be implemented by an apparatus and/or by a computer program stored on a computer readable medium. The computer readable medium may comprise a disk, a client device, a network device, and/or a propagated signal.

Other features and advantages will be apparent from the following description, including the drawings, and from the claims.

### DESCRIPTION OF THE DRAWINGS

FIG. 1 illustrates a retrofit electronic lock (REL) unit according to one embodiment of the present invention.

FIGS. 2A-2C illustrate a lock mechanism according to one embodiment of the present invention.

FIG. 3 is a block diagram of REL electronics according to one embodiment of the present invention.

FIG. 4 illustrates a REL system according to one embodiment of the present invention.

FIG. 5 illustrates a REL system according to one embodiment of the present invention.

FIG. 6 is a flow chart of a REL method according to one embodiment of the present invention.

### DETAILED DESCRIPTION

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. In addition, it will be appreciated that the characterizations of various components and orientations (e.g., vertical or horizontal, right or left, side, top, bottom, upper or lower) shown and described herein are relative characterizations only based upon the particular position or orientation of a particular embodiment.

In one general aspect, a retrofit electronic lock (REL) unit is mounted to a key operated coin locker to provide a technically and functionally superior electronic lock while requiring minimal modification an existing locker system. The REL unit thus provides an upgrade path to customers that would like to realize the benefits of a keyless operation while leveraging their current locker investment.

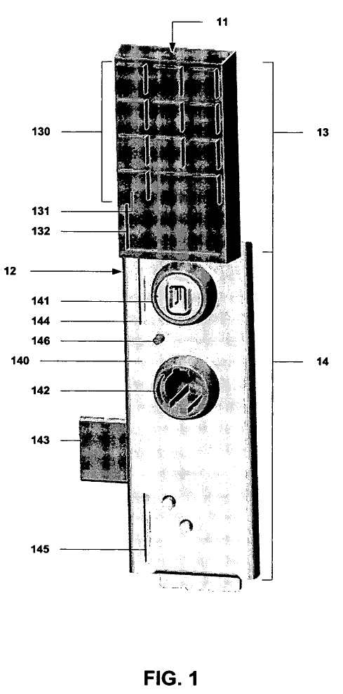

FIG. 1 illustrates an exemplary retrofit electronic locker (REL) unit 10 according to aspects of the present invention. As shown, the REL unit 10 includes a housing 11, a bezel 12, a user interface 13, and a lock mechanism 14. In general, the housing 11 accommodates the user interface 13 and environmentally seals the internal electronics (not shown). The housing 111 also allows semi-permanent attachment to the lock channel of an existing locker system.

In one embodiment, the housing 11 is constructed of injection-molded plastic. Other examples of suitable materials include but are not limited to: metals and alloys such as stainless steel, aluminum, beryllium, brass, bronze, cast iron, copper, lead, magnesium, tantalum, zinc, zirconium, and various other trademarked alloys; ceramics such as glass and porcelain; and plastics such as Acrylonitrile-butadiene-styrene (ABS) resin, acetal resin, acrylic resin, fluorocarbon polymer, nylon, phenolformaldehyde resin, polybutilene terephthalate, polycarbonate, polyethylene, polyphenylene oxide, polypropylene, polystyrene, reinforced plastics (FRP), ureaformaldehyde resin, acrylic, polyurethane, polyvinylchloride (PVC), thermoplastics, thermoset plastics, and any combinations and/or compositions thereof including fiber reinforced and carbon fiber reinforced combinations and/or compositions thereof.

In one embodiment, the bezel 12 is sized for compatibility with a coin and key operated locker cabinet without interfering with adjacent columns and without restricting access to the bottom coin hopper. The locker cabinet may be 72″ high and include six 11.25″ doors, for example.

The REL unit 10 includes a user interface 13 to configure an associated locker. In one embodiment, the user interface 13 includes a keypad 130 having a matrix of keys 131 for registering keystrokes and a display panel 132. In one implementation, the keypad 130 includes a matrix of hard plastic or metal key caps with tactile feel. Other examples of suitable materials include, but are not limited to, a polycarbonate membrane type keypad. The keys included are “0”, “1”, “2”, “3”, “4”, “5”, “6”, “7”, “8”, and “9”. In some cases, a “CANCEL” key may be provided. There also may be arrow keys to control certain functions (e.g., management functions). In some implementations, the keypad may include the capability of receiving and/or recognizing biometric inputs (e.g., finger prints).

In general, the display panel 132 is configured to display messages and/or instructions to the user regarding the operation of an associated locker. In one embodiment, the display includes a rear mounted, character backlit LCD display with a polycarbonate, double-sided hard coated lens. The display panel 132 may be implemented as a vacuum florescent display (VFD) screen, a liquid crystal display (LCD), and/or a light emitting diode (LED) display, for example. In some implementations, the display panel 132 may include a touch screen incorporating the functionality of the keypad 130 to receive user input. In some implementation, the REL unit 10 also may include product labeling for providing operating instructions placed inside the door. The instructions may be providing in multiple languages (e.g., English, French, Spanish, German, Italian).

The REL unit 10 includes a lock mechanism 14. In general, the lock mechanism 14 is configured for attachment to the lock channel of a coin and key operated locker cabinet without disturbing the existing functions inside the cabinet. In one embodiment, the lock mechanism 14 includes a lock face 140 having a first (top) cylinder 141 for maintaining control key functionality of an existing locker system to which the REL unit 10 is mounted. In general, a control key is a master key provided to select personnel that can be used to remove the lock assembly and provide service in the case of a damaged or malfunctioning lock.

The lock mechanism 14 also includes a second (patron) cylinder 142 used to manually throw and retract a deadbolt 143. In general, the position of the second cylinder 142 corresponds to a position of a key slot in an existing coin and key locker. In some implementations, the REL unit 10 is battery powered. As such, requiring the deadbolt 143 to be moved manually conserves a substantial amount of power. The lock mechanism 14 further includes a first slot 145 for capturing coins or tokens, a second slot 146 for returning the coins or tokens, and a pin 146 for sensing door position.

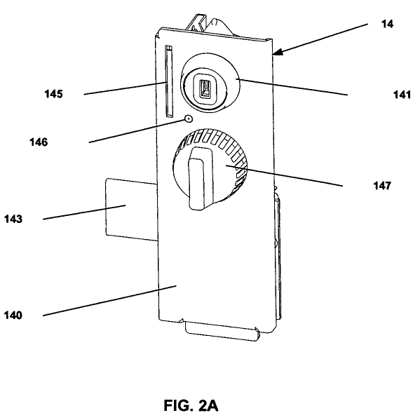

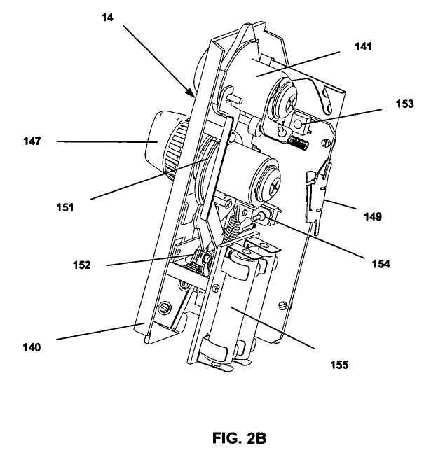

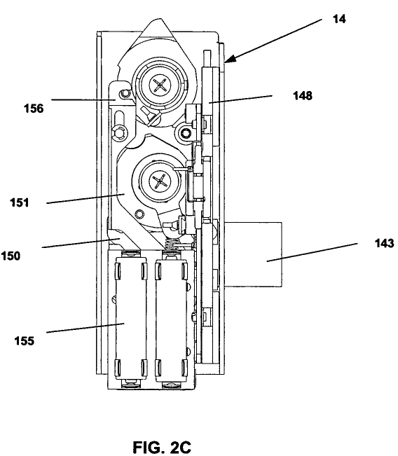

FIGS. 2A-2C illustrate one embodiment of a lock mechanism 14. FIG. 2A depicts a lock mechanism 14 including a lock face 140 having control key cylinder 141. As shown, a patron knob 146 is included in the second cylinder. The position of the patron knob 147 is used to manually throw and retract the deadbolt 143 and visually indicates the locked and unlocked position. The lock mechanism includes a slot 145 for capturing coins or tokens and a pin 146 for sensing door position.

Referring to FIGS. 2B and 2C, the lock mechanism includes a coin chute assembly 148 structured and arranged so that coins drop in an organized fashion into a coin collection receptacle. In some implementations the lock mechanism 14 may accepts a predetermined maximum number of tokens (e.g., two or three) or coins (e.g., quarters, dollars). In some implementations, the coins or tokens are held in “escrow” until the lock is turned to the locked position. In some embodiments, there may be no provision for coin return. In some implementations, the coins or tokens may be sensed by a coin sensor 149 (e.g., feeler springs) when inserted.

The deadbolt 145 can be triggered, for example, by moving a lock pawl 150 in and out of the teeth of a lock cam 151 or gear or cam stop posts. Namely, when the lock pawl 150 is placed between the teeth or posts of the lock cam 151, the patron knob 147 is prevented from turning. A solenoid 152 or motor removes the lock pawl 150 from between the teeth or posts of the lock cam 151 so that the patron knob 147 can be turned to throw or draw back the dead bolt 143. As shown, the lock mechanism 14 includes a control key sensor 153, a deadbolt position sensor 154, a power source 155, and a control key reset arm 156.

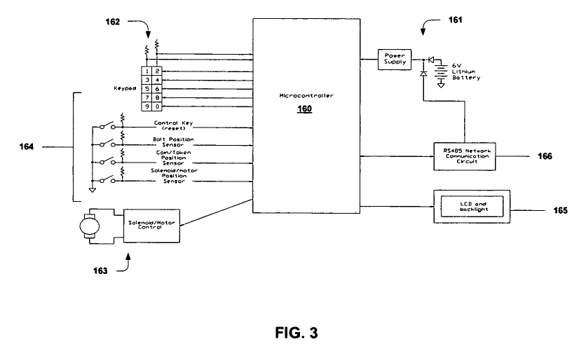

FIG. 3 illustrates a diagram of electronics 16 that may be used with the REL unit 10. The general, the electronics 16 are structured and arranged to fit inside a cavity inside the lock channel. In one embodiment, the electronics 16 include a micro-controller 160, a power supply 161, a keypad decoder 163, micro-switch sensors 164, a display controller 165, and a network interface 166.

In general, the micro-controller 160 controls the functionality of the REL unit 10. The micro-controller 160 may control one, some, or all of the elements of the REL unit 10. The micro-controller 160 may control functions including event time/date recording, audit trail and usage recording, open all locks command, open individual lock command, keypad status monitoring and control including pass code, last code review with control key, codes locked out, anti-tamper, incorrect code detection and lockout, diagnostics (e.g., low battery detection), networked power distribution, network communication, the lock bolt position, the management control reset, and coin/token insertion.

In general, the micro-controller 160 may include any type of computer-readable storage capable of storing data. Examples include, but are not limited to, EPROM for storing permanent data, EEPROM for storing operator programmable data, and/or RAM for storing temporary data. In one implementation, the memory stores a control program including instructions for directing the operation of the REL unit 10.

One example of a control program is a computer program. Other examples include a software application, a piece of code, an instruction, another device, or some combination thereof. The control program may be implemented as computer code utilizing any suitable computing language (e.g., Java, C or C++). The control program also may be a computer, such as a workstation or PC, a microprocessor, a network server, a Java virtual machine, or an application specific integrated circuit, using any suitable type of computer instructions.

The control program may be embodied permanently or temporarily in any type of machine, component, physical or virtual equipment, storage medium, or propagated signal capable of providing instructions to a device. In particular, the control program (e.g., software application, computer program) may be stored on a storage media or device (e.g., ROM, magnetic diskette, or propagated signal) readable by a computer system, such that if the storage media or device is read by the computer system, the functions described herein are performed.

In one implementation, the power supply 161 may include one or more of battery power and network power. In one embodiment, the power supply includes a 9 VDC or one or more 1.5 VDC batteries, for example. In some cases, the REL unit 10 has the capability of operating from 3-15 VDC and permits transparent conversion from battery to network power and network power to battery.

As shown, the electronics 16 includes a solenoid/motor controller 163 for inhibiting and releasing the lock. For example, the controller 163 may instruct the solenoid/motor to move a pawl in and out of the teeth of a cam or gear. In one embodiment, when the pawl is placed between the teeth of a cam or gear, the handle of the REL unit 10 is prevented from turning to inhibit both opening and closing the lock. When the solenoid/motor removes the pawl from between the teeth, the handle is release allowing a user to manually turned the knob to throw or draw back the deadbolt.

In one embodiment, the electronic 16 include sensors 164 for lock bolt position, coin/token, and control key. In some implementations, the door position can be monitored, and the pawl can be moved between the teeth or posts to keep the door from locking.

In one embodiment, the REL unit 10 includes a network interface 166. In general, the network interface 166 may include any type of communications interface enabling wired or wireless communication. Examples include, but are not limited to, a modem, a transceiver, a communication card (e.g., a RS485 to RF and/or a RS485 to IR communication card), a transmitter, and/or another network adapter capable of transmitting and receiving data over a wired or wireless data pathway.

In one embodiment, the network interface 166 includes a RS485 interface utilizing a standard RJ45 based Ethernet cable and RS485 signaling to link multiple remote keypad together in a daisy chain bus arrangement. Accordingly, the network interface 166 may include a master bus originating from the host on the daisy chain bus.

In one implementation, only one master is permitted per bus, and all other master bus drivers on the bus are disabled to prevent collision. Responses from all REL units are transmitted on a slave bus and eventually routed to the host. Responders enable their transmitters to the slave bus when necessary to reply to a command and immediately disable the transmitters as soon as the packet is sent.

In some implementations, the REL unit 10 may communicate with a host and/or a client through a network. In one implementation, the REL unit 10 is configured to provide locker information to the host and/or client. Examples of lock information include, but are not limited to, unit information, start time, stop time, utilization, revenue, and/or operating status.

In general, the network may include an information delivery network supporting a variety of telecommunications and/or data services including Internet and/or web access, e-mail and/or instant messaging services, paging services, audio and/or video streaming, and/or directory services. Examples of networks include, but are not limited to, a local area network (LAN), a wide area network (WAN), a telephone network (e.g., analog, digital, wired, wireless, PSTN, ISDN, or xDSL), a radio network, a television network, a cable network, a satellite network, and/or any other communications network configured to carry data. Each network may include one or more elements, such as, for example, intermediate nodes, proxy servers, routers, switches, adapters, and wired or wireless data pathways, configured to direct and/or deliver data.

Examples of a host include a personal computer (PC) or server equipped with an appropriate interface that issues data commands and information requests to the network. Examples of a client include a PC, an Internet-enabled handheld device, and an Internet-enabled mobile telephone. The host and or client also may be implemented as a microprocessor, a network server, a virtual machine, or an application specific integrated circuit, using any suitable type of computer instructions.

In some implementations, the host may include a web server that provides real time information over the Internet and/or World Wide Web. In such cases, the information may be represented as specially formatted text files (e.g., Web pages) written in Hypertext Markup Language (“HTML”) or some other markup language, such as XML, HDML, and/or VRML. Each text file may be identified by a network address such as a Universal Resource Locator (“URL”).

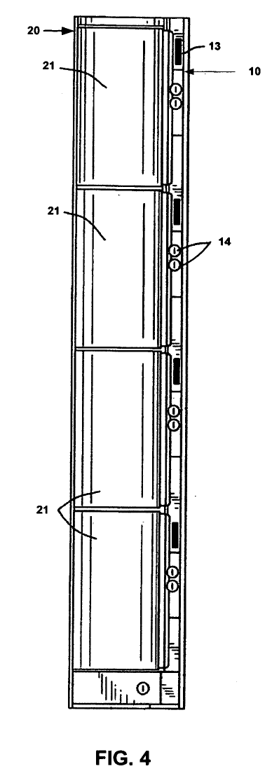

FIG. 4 illustrates an exemplary locker system 100 according to one embodiment of the present invention. As shown, the locker system 100 includes a plurality of REL units 10 mounted to a locker system 20 having a plurality of locker doors 21. As shown, each REL unit 10 is secured to the lock channel. The lock channel is on the right-hand side of the locker and is the receptacle for the locks. In general, mounting each of the REL units 10 to the lock channel mounted device requiring a minimum of modification to the existing lock channel.

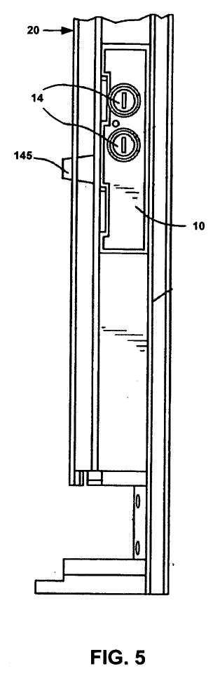

FIG. 5 illustrates an exemplary locker system 100 according to one embodiment of the present invention. As shown, the locker system 100 includes a REL unit 10 mounted to a locker system 20. As shown, each REL unit 10 includes a deadbolt 145 that can be thrown and drawn back by the locking mechanism 14.

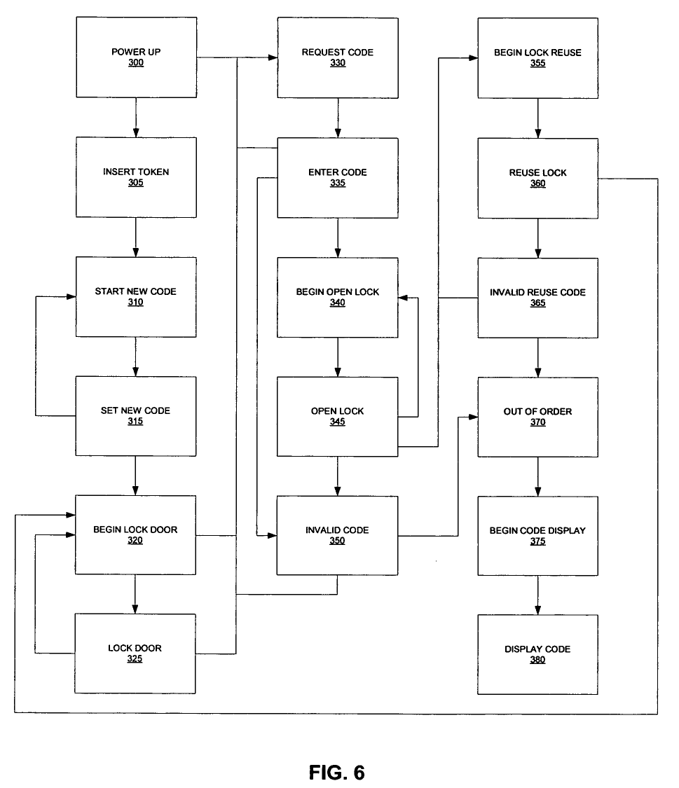

Referring to FIG. 6, a REL unit 10 operates according to a procedure 30. The procedure 30 may be implemented by any suitable type of hardware (e.g., device, computer, computer system, equipment, component); software (e.g., program, application, instructions, code); storage medium (e.g., disk, external memory, internal memory, propagated signal); or combination thereof.

At the power-up step (S300), the REL system is initialized. The lock inhibits the handle from turning and throwing the bolt. In some implementations, the display panel may be customized to display a vendor or manufacture name. The price, coin or token and number of digits in the code (4 to 8). After initialization, the REL system holds for a predetermined delay period (e.g., five seconds) and then proceeds to either an insert token state (S305) or a request code state (S330). If the door is unlocked after the power-up state (S300), the REL system proceeds to the insert token state (S305). On the other hand, if the door is locked, the REL system proceeds to the request code state (S330).

At the inserted toke state (S310), the locker door is unlocked, but the lock inhibits the handle from turning and throwing the bolt. The REL system waits for the required number of tokens or the required currency amount to be inserted, and the display panel many present a message instructing the user to insert a required number of tokens or the required currency amount. The lock is in an inhibit state preventing the handle from turning and throwing the bolt. When the required number of tokens or the required amount is inserted, the REL system proceeds to a start new code state (S310).

At the start new code state (S310), the locker door remains unlocked, and the lock still inhibits the handle from turning and throwing the bolt. The REL system waits for any key to be pressed, and the display panel may present a message instructing the user to enter a code. As soon as the user presses the first key, the REL system proceeds to a set new code state (S315).

At the set new code state (S315), the user continues to enter a new code for an associated locker. The display panel many present a message to the user indicating a code is being entered. For example, the display may present an asterisk (“*”) for each key pressed. The locker door remains unlocked, and the lock continues to inhibit the handle from turning and throwing the bolt. As soon as the last digit of the code is entered, the REL system proceeds to the begin lock door state (S320). If a CANCEL key is pressed, the REL system may return to the start new code state (S310).

At the begin lock door state (S320), the REL system waits for the lock sensor to indicate that the user has locked the door. The display panel may present a message instructing the user to lock the door. The lock is released to allow the handle to turn and throw the bolt. The REL system holds for a predetermined delay period (e.g., 1.5 seconds) and then proceeds to a lock door state (S325). If the lock sensor trips, the REL system proceeds to a request code state (S330).

At the locked door state (S325), the REL system waits for the lock sensor to indicate that the user has locked the door. The display panel may present a message instructing the user to turn the knob. The lock is released to allow the handle to turn and throw the bolt. The REL system holds for a predetermined delay period (e.g., 1.5 seconds) and then returns to the begin lock door state (S320) if the lock sensor is not tripped. If the lock sensor trips, the REL system proceeds to a request code state (S330).

At the request code state (S330), the REL system waits for the user to return and enter a code to gain access to the locker. The door is locked, and the lock inhibits the handle from turning. The display panel may present a message instructing the user to enter a code. The REL waits for the user to press any key. As soon as the first key is pressed, the REL system proceeds to an enter code state (S335).

At the enter code state (S335), the user continues to enter a code. The display panel many present a message to the user indicating a code is being entered. For example, the display may present an asterisk (“*”) for each key pressed. The locker door remains locked, and the lock continues to inhibit the handle from turning. As soon as the last digit of the code is entered, the REL system verifies the entered code against the original code. If the codes match, the REL system proceeds to the begin open lock state (S340). If the codes do not match, the REL system proceeds to an invalid code state (S350). If a CANCEL key is pressed, the REL system returns to the request code state (S330).

At the begin open lock state (S340), the REL system waits for the lock sensor to indicate that the user has unlocked the door. The display panel may present a message instructing the user to turn the knob. The lock is released to allow the handle to turn and draw back the bolt. The REL system holds for a predetermined delay period (e.g., 1.5 seconds) and then proceeds to an open lock state (S345). If the lock sensor trips, the REL system proceeds to a begin lock reuse state (S355).

At the open lock state (S345), the REL system waits for the lock sensor to indicate that the user has unlocked the door. The display panel may present a message instructing the user to open the door. The lock is released to allow the handle to turn and throw the bolt. The REL system holds for a predetermined delay period (e.g., 1.5 seconds) and then returns to the begin lock door state (S340) if the lock sensor is not tripped. If the lock sensor trips, the REL system proceeds to the begin lock reuse state (S355).

At the invalid code state (S350), the REL system indicates that an invalid code was entered. The lock inhibits the handle from turning keeping the door locked. The display panel may present a message informing the user that the code is not accepted. The REL system holds for a predetermined delay period (e.g., 1.5 seconds) and then returns to request code state (S330). If a threshold number (e.g., five) of invalid codes are consecutively entered, the REL system proceeds to an out of order state (S370).

At the begin lock reuse state (S355), the REL system allows a user to reuse the lock. The lock inhibits the handle from turning to hold the door. The REL system waits for the user to enter any key. The display panel may present a message requesting the user to enter a code. As soon as the first key is pressed, the REL system proceeds to the reuse lock state (S360).

At the reuse lock state (S360), the user continues to enter a code. The display panel many present a message to the user indicating a code is being entered. For example, the display may present an asterisk (“*”) for each key pressed. The locker door remains unlocked, and the lock continues to inhibit the handle from turning to hold open the door. As soon as the last digit of the code is entered, the REL system verifies the entered code against the original code. If the codes match, the REL system proceeds to the begin lock door state (S320). If the codes do not match, the REL system proceeds to an invalid reuse code state (S365). If the REL system receives no response for a predetermined delay period (e.g., 2 minutes), the REL system returns to the insert token state (S305).

At the invalid reuse code state (S365), the REL system indicates that an invalid code was entered. The lock inhibits the handle from turning keeping the door opened. The display panel may present a message informing the user that the code is not accepted. The REL system holds for a predetermined delay period (e.g., 1.5 seconds) and then returns to the begin lock reuse state (S355). If a threshold number (e.g., five) of invalid codes are consecutively entered, the REL system returns to the insert token state (S305).

At the out of order state (S370), the REL has received a predetermined number (e.g., five) of illegal pass code attempts or a system malfunction has occurred. The lock inhibits the handle from turning and throwing the bolt. The door is locked, and the REL system waits to be reset by a control key or power cycle. The display panel may present an out of order message. When the REL is reset upon the insertion of a control key, it proceeds to a begin code display state (S375).

At the begin code display state (S735), the REL system displays the last known code number for querying purposes when a control key is inserted and turned. The REL system then proceeds to a display code state (S380).

At the display code state, the last known code number is displayed, and the control key is released. If the door is locked, the REL system proceeds to either the request code state (S330). If the door is unlocked, the REL system proceeds the begin reuse lock state (355).

It is to be understood that component and sub-assemblies will be evaluated for suitability and reliability as well as to verify compliance with the operating characteristics and environmental specifications. For example, embodiments of the REL system may comply with one or more of: FCC requirements for computing devices, applicable North American safety directives, applicable Canadian CSA safety directives, applicable European safety directives, and EM50082-1 (immunity) and EN50081-1 (emissions).

The factors affecting reliability may relate to the performance of the keypad, the electronics, the lock enclosure, the bezel and mechanism, the cabling and wiring systems, the network repeater hubs, the local power supplies, and the software.

The examples presented herein are intended to illustrate potential implementations of the present method and system embodiments. It can be appreciated that such examples are intended primarily for purposes of illustration. No particular aspect or aspects of the example method and system embodiments described herein are intended to limit the scope of the present invention.

It also can be appreciated that, in some embodiments of the present methods and systems disclosed herein, a single component can be replaced by multiple components, and multiple components replaced by a single component, to perform a given function. Except where such substitution would not be operative to practice the present methods and systems, such substitution is within the scope of the present invention.

A number of embodiments and implementations have been described. Nevertheless, it will be understood that various modifications may be made and that other embodiments and implementations are within the scope of the following claims.

1. A locker unit comprising:
a housing structured and arranged to be retrofit to an existing key operated locker; and
an electronically controlled locking mechanism enabling keyless entry into the locker.

2. The locker unit of claim 1, further comprising a user interface for receiving an entry code from a user.

3. The locker unit of claim 2, wherein the user interface comprises a keypad.

4. The locker unit of claim 2, wherein the user interface comprises a display panel.

5. The locker unit of claim 4, wherein the display panel comprises at least one of a vacuum florescent display, a liquid crystal display, and a light emitting diode display.

6. The locker unit of claim 1, wherein the locking mechanism is mounted to a lock channel of an existing key operated locker system.

7. The locker unit of claim 1, wherein the locking mechanism comprises a cylinder for receiving a control key.

8. The locker unit of claim 1, wherein the locking mechanism comprises a cylinder including a knob.

9. The locker unit of claim 8, wherein turning the knob moves a deadbolt.

10. The locker unit of claim 9, wherein the knob is turned manually by a user.

11. The locker unit of claim 1, further comprising one or more coin slots.

12. The locker unit of claim 1, further comprising electronics structured and arranged to fit inside a cavity of a locker door.

13. The locker unit of claim 12, wherein the electronics comprise a micro-controller performing one or more of: event time and date recording, audit trail and usage recording, open all locks command, open individual lock command, keypad status monitoring and control including pass code, last code review, no codes locked out, anti-tamper, incorrect code detection and lockout, diagnostics, networked power distribution, and network communication.

14. The locker unit of claim 12, further comprising a power supply including one or more of a battery and network power.

15. The locker unit of claim 12, further comprising a motor controller for instructing a motor to inhibit and release the electronic locking mechanism.

16. The locker unit of claim 12, further comprising sensors for detecting at least one of bolt position, coin insertion, token insertion, control cylinder, and power level.

17. The locker unit of claim 12, further comprising a network interface.

18. A method comprising:
receiving an entry code through an electronically controlled locking mechanism retrofit to an existing key operated locker; and
proving keyless entry into the locker when the entry code is subsequently entered.

19. A computer program stored on a computer-readable medium, the computer program comprising instructions to:
receive an entry code through an electronically controlled locking mechanism retrofit to an existing key operated locker; and
prove keyless entry into the locker when the entry code is subsequently entered.

20. The computer program of claim 19, wherein the computer-readable medium comprises at least one of a disk, a client device, a network device, and a propagated signal.
